(19) United States
(12) Patent Application Publication
(10) Pub. No.: US 2021/0261850 A1
(43) Pub. Date: Aug. 26, 2021

(54) COMPOSITIONS FOR BITUMEN, ASPHALTENE, PARAFFIN, SOIL CONTAMINANT REMOVAL, FACILITY CLEANING, AND RESERVOIR PRODUCTION ENHANCEMENT

(71) Applicant: Anthony SARVUCCI, Calgary (CA)

(72) Inventor: Anthony SARVUCCI, Calgary (CA)

(21) Appl. No.: 17/187,400

(22) Filed: Feb. 26, 2021

Related U.S. Application Data
(60) Provisional application No. 62/981,761, filed on Feb. 26, 2020.

(51) Int. Cl. C09K 8/524

(52) U.S. Cl. CPC C09K 8/524

(57) ABSTRACT

A surfactant blend includes at least one alcohol ethoxylate surfactant, at least one amine oxide surfactant, and at least one quaternary ammonium surfactant.

### CROSS-REFERENCE TO RELATED APPLICATION

This application claims the benefit of U.S. Provisional Application Ser. No. 62/981,761, filed on Feb. 26, 2020, which is incorporated herein by reference in its entirety.

### FIELD OF THE INVENTION

The present invention relates to compositions for use in the oil and gas industry.

### BACKGROUND OF INVENTION

Hydrocarbons including oil and bitumen are routinely extracted from the earth.

The separation of bitumen from bituminous sand may be achieved by (a) the injection of steam into the bitumen deposit, followed by pumping the condensed steam (water) mixed with bitumen to the surface or (b) mining the bituminous sands and processing with hot water to produce a slurry which is then subjected to gravity separation.

The first stage of hydrocarbon production, in which natural reservoir energy, such as gasdrive, waterdrive or gravity drainage, displaces hydrocarbons from the reservoir, into the wellbore and up to surface. The second stage of hydrocarbon production during which an external fluid such as water or gas is injected into the reservoir through injection wells located in rock that has fluid communication with production wells. The most common secondary recovery techniques are gas injection and waterflooding. The secondary recovery stage reaches its limit when the injected fluid (water or gas) is produced in considerable amounts from the production wells and the production is no longer economical. The successive use of primary recovery and secondary recovery in an oil reservoir produces about 15% to 40% of the original oil in place. Oil-based reservoirs may realize increased production through tertiary recovery techniques such as thermal recovery, chemical injection and gas injection which reduce the interfacial tension between the hydrocarbon molecules and the formation matrix.

The above-described techniques require the use of various equipment including pipes (termed “tubulars”), tanks, rigs and treatment facilities.

The extraction and processing of bitumen and oil-based hydrocarbons may result in undesirable deposits of bitumen, oil, asphaltenes, paraffins, scale precipitation and NORMS (naturally occurring radioactive materials) and other petroleum products on equipment, and such may be very difficult to remove. Current examples of chemicals used to dissolve, remove and clean bitumen include white spirit (Varsol™), xylene, oil-based cleaning chemicals, and condensate, all of which are toxic to humans, wildlife, and the environment.

Moreover, precipitation of wax and asphaltenes with production operations, coupled with interfacial tension, may lead to bypassed (i.e. unrecovered) oil when flooding a reservoir.

It is an object of the invention to provide a cleaning/solvent composition which is effective at preventing or removing build-up of bitumen, oil, and the associative deposits while at the same time posing low risk to human health and environmental safety.

It is a further object of the invention to provide a composition which is capable of breaking oil water emulsions and/or reducing interfacial tension.

It is still a further object of the invention to provide a composition for use in improving hydrocarbon production.

It is yet a further object of the invention to provide a composition for use in cleaning soil after an oil spill.

### SUMMARY OF INVENTION

Disclosed herein are compositions which have been found to be effective for applications such as oil tank clean outs, cleaning of tools on a wireline, production tank clean outs, rig washes and cleaning of oil treatment facilities and gathering systems. The compositions may also be useful downhole to increase production on plugged and or underperforming wells, for cleaning SAGD plants and may also work in a water flood application.

The compositions include a surfactant blend which includes at least one alcohol ethoxylate surfactant such as ethoxylated C9-C11 alcohol, at least one amine oxide surfactant such as lauryl dimethylamine oxide, and at least one quaternary ammonium surfactant, such as .PEG-15 cocomonium chloride.

The compositions are also useful for the following applications:
Breaking water and oil emulsions; thereby clarifying water to reduce carryover effects from hydrocarbon production,
Coating tubulars to inhibit the deposition of asphaltenes, paraffin, and scale,
Dispersing established paraffin and asphaltenes,
Improving reservoir sweep efficiency and flow enhancement though the perforation tunnels,
Provides residual benefit to aid flowline and production facility operations through the removal and inhibition of paraffin, asphaltene and scale deposits,
Reducing interfacial tension when used as a waterflood additive, and
When used to clean soil that has been exposed to oil spills, it helps liberate oil from the soil, making for easier clean up.

The compositions described herein were developed with two general goals in mind; one being to improve sweep efficiency, and two to break the bonds of depositing forces with tubulars. This allows asphaltene and paraffin deposits to be kept in a liquid phase and limit their deposition in formations, down hole tubulars, gathering system and surface facilities. By reducing the choke points, the production operator uses the present compositions to reduce the energy required to move the fluids, and then circumvents issues such as under-deposit corrosion, reduced pipeline diameters, and vessel plugging. When passed through the reservoir, it reduces the viscosity of the oil, drag forces, and helps separate the bonds with the reservoir through the reduction of interfacial tension. As a result, the operator spends more time producing, realizes increased production rates through the passage of the chemical through the reservoir, and less time dealing with production problems.

The compositions described herein can be applied as a waterflood enhancement strategy, a production enhancement strategy, as a stimulation strategy, or to assist with workover operations. The compositions described herein can be deployed in the following general manners:
As part of a water additive when augmenting a waterflood enhancement strategy,
As a spacer pill when pigging flowlines,
Batch or continuous injection,
Hot oil/hot water treatments,
Perforation flushes down the annulus or through tubing, or
When treating surface spills, applied directly to the soil as an oil breaking agent; assisting with reclamation activities.

The product is effective at room temperature, but is also effective when heated. The ideal treating range is 50-80 degrees C., but being a water-based chemical, it is effective to 100 degrees before the water component begins to boil off. When superheated up to 380 degrees C., the entire composition vaporizes and has proven effective in a lab for applications such as SAGD (steam assisted gravity drainage) enhancement. In this scenario, the vaporized molecules enter the SAGD reservoir, advance through the steam chamber, strip previously bypassed oil, and then the reservoir realizes the added benefit of production enhancement as the molecules condense back into liquid and reduce the interfacial tension of the bitumen as it gravity feeds to the horizontal production leg.

The compositions may be useful as heavy oil production enhancement additives, bitumen additives, facility cleaning agents, soil cleaning agents, paraffin/scale/asphaltene inhibiting agents, or paraffin reduction agents during hydrocarbon production.

Additionally, compositions disclosed herein may be used for general purpose and household cleaning.

The compositions disclosed herein have been found to be effective at removing, dissolving or cleaning bitumen/oil/wax deposits on equipment, and comprise biodegradable and non-toxic ingredients which pose low risk to human health and environmental safety when used in a dilute form.

### DETAILED DESCRIPTION

The compositions disclosed herein comprise a surfactant blend comprising at least one alcohol ethoxylate surfactant, at least one amine oxide surfactant and at least one quaternary ammonium surfactant.

The alcohol ethoxylate surfactant may be a linear or branched alcohol ethoxylate and may be a primary or secondary alcohol ethoxylate. The alcohol ethoxylate may be based on an alcohol having approximately 8-18 carbon atoms, 8-16 carbon atoms, 8-14 carbon atoms, 8-12 carbon atoms, or 9-11 carbon atoms. The alcohol ethoxylate may have between 3-12 ethylene oxide units. An exemplary alcohol ethoxylate is ethoxylated C9-C11 alcohol, commercially available under the designation Masodol™ 91-6 by Pilot Chemical. Tomadol 91-6 by Air Products, Masurf™ 916M, Masurf™ 1250 and 1250A, and Masodol 1-3 [poly(oxy-1 2-ethanediyl) .alpha.-undecyl-.omega.-hydroxy-] are other possible alcohol ethoxylates.

The amine oxide surfactant may be of the structure NRR′R″O, where R is C₆₋₂₄ alkyl, and R′ and R″ are both C₁₋₄ alkyl, although R′ and R″ do not have to be equal. An exemplary amine oxide is lauryl (C12) dimethylamine oxide, for example Macat™ AO-12 by Pilot Chemical. Other possible amine oxides include Macat™ AO-8 (octyl dimethylamine oxide) and Macat™ AO-8 Special by Pilot Chemical.

The quaternary ammonium surfactant may be of the structure N⁺R₁R₂R₃R₄ where R₃ and R₄ are (CH₂CH₂O)ₙH, R₁ is C₇₋₁₄ or C₉₋₁₂ or C₁₂, and R₂ is C₁₋₄ alkyl. R₃ and R₄ are polyethylene glycol (PEG), and the PEG may have a total molecular weight of approximately 10-20 g/mol, or 12-18 g/mol, or 14-16 g/mol, or 15 g/mol. The quaternary ammonium may be formulated as a suitable salt, such as a halide salt, for example a chloride, fluoride, bromide or iodide. An exemplary quaternary ammonium is PEG-15 cocomonium chloride, for example Maquat™ C-15 by Pilot Chemical, or PEG-15 cocomonium methosulfate, for example Maquat™ C-15MS by Pilot Chemical.

It has been found that the inclusion of a quaternary ammonium surfactant such as PEG-15 cocomonium chloride improves the performance of the composition and its ability to break oil and water emulsions (see in particular examples 15, 17 and 18 below).

Other surfactants which may be included are benzyl ammonium chloride surfactants such as Maquat MQ2525M—50% and alkyl betaines such as Macat™ LB/CB/LCB.

Optionally, an additional cationic surfactant may be included.

In addition to the surfactant blend, the composition may further comprise a suitable chelating agent or sequestering agent to reduce the likelihood that heavy metals present in the water or bitumen will interfere with the effectiveness of the composition. Any suitable chelating agent known in the art may be used, including but not limited to ethylenediaminetetraacetic acid (EDTA) (tetrasodium EDTA, disodium EDTA or calcium disodium EDTA), iminodisuccinic acid (IDS), polyaspartic acid, S,S-ethylenediam in-N, N′-disuccinic acid (EDDS), and methylglycinediacetic acid (MGDA).

The composition may further include a buffer, alkaline source or acid source to maintain the composition at a stable and suitable pH. As oil and gas reservoirs are slightly acid to slightly basic, the ideal pH range of the composition is between 5 and 9, or between 5.5 and 8.5, between 6 and 8, or between 6.5 and 7.5. Any suitable buffer known in the art may be used, including but not limited to ammonium chloride, trisodium citrate, acetic acid, and sodium acetate. Other buffers are possible and will be known to those skilled in the art.

The composition may additionally include a builder to improve its cleaning properties by sequestering calcium and magnesium ions, providing an alkaline environment, enhancing surfactant performance and/or desorbing soil. Any suitable builder known in the art may be used, including but not limited to sodium metasilicate, sodium tripolyphosphate, sodium hexametaphosphate, sodium phosphate, tetrasodium pyrophosphate, sodium bicarbonate, sodium carbonate, sodium carboxymethylcellulose, sodium silicate and sodium chloride.

The composition also includes water, which may be deionized water or softened water.

To counteract cold weather operations, methanol or similar products to resist freezing may be included.

The composition may include additional ingredients which provide desired properties and functionalities to the composition. Such additional ingredients may include, for example, hydrotropes, enzymes, surfactants, disinfectants, sanitizers, acidulants, complexing agents, corrosion inhibitors, foam inhibitors, stabilizing agents, dyes, thickening agents and perfumes.

The diluted composition may comprise about 1.5% to about 10% by weight chelating agent, or about 5.5% to about 6.5% by weight chelating agent; about 1.5% to about 7% by weight buffer or acid source, or about 5.5% to about 6.5% by weight buffer or acid source; about 0.5 to about 3.5% by weight builder, or about 1% builder or about 3% builder; and about 15% to about 19% by weight surfactant blend, or about 16% to about 18% by weight surfactant blend, or about 17% by weight surfactant blend; and about 60% to about 80% by weight water, or about 65% to about 75% by weight water, or about 67% to about 73% by weight water, or about 69% to about 71% by weight water, or about 70% by weight water.

### Exemplary Compositions

### Composition 1:

| Ingredients | Wt. % |
|---|---|
| Trisodium citrate (100%) | 6.0 |
| Na₄EDTA (40%) | 6.0 |
| Masodol 91-6 | 4.0 |
| Macat AO-12 | 3.0 |
| Maquat C-15 | 3-10.0 |
| Cationic surfactant | 0-5 |
| Sodium metasilicate 5H2O | 1.0 |
| Fresh Water | Balance |

In an embodiment, the composition may be made as follows:
Water—warm—70% to start
dissolve sodium metasilicate 5H2O
dissolve trisodium citrate
mix until all powders fully dissolved
add EDTA
then add 91-6 (alcohol ethoxylate), AO-12 (amine oxide) and Maquat C-15 (quaternary ammonium surfactant)—then top up with COLD water

Further dilution or subtraction of water, and temperature can vary based on application.

When applying this solution to break down oil to a higher viscosity the composition is preferably added at 40° C. or above for the solution to bond to the oil and allow it to immobilize it. This is a temporary suspension and the solution will eventually separate from the oil as oil and water don't naturally mix. Usually within a 24 hr period.

The following compositions may be useful for household or general cleaning.

### Composition 2:

| Masodol 91-6 | 10.0 |
|---|---|
| (alcohol ethoxylate) | |
| Masodol 1-3 | 10.0 |
| (narrow, range linear primary alcohol ethoxylate) | |
| Na₄EDTA, 38% | 10.0 |
| Maquat MQ2525M-50% | 3.125 |
| (dimethyl benzyl ammonium chloride, | |
| dimethyl ethylbenzyl ammonium chloride) | |
| Sodium Metasilicate 5H₂O | 3.0 |
| Water | Balance |

Composition 2 effective at cleaning granite counter without streaks, removed red wine and sharpie stains from carpet, without leaving a residue, cleaned painted door without removing any paint, cleaned shower doors without residue, cleaned oven top well with scrubbing, cleaned stainless steel with minimal streaking, cleaned a greasy pan with baked on food residue (with scrubbing), cleaned grease off a grill, cleaned grease off oven door.

### Composition 3:

| Ingredients | Wt. % |
|---|---|
| Na₄EDTA, 38% | 10.0 |
| Maquat C-15 | 5.0 |
| Maquat MQ2525M-50% | 3.125 |
| Sodium Metasilicate 5H₂O | 3.0 |
| MASODOL 91-6 | 3.0 |
| Water | Balance |

### Composition 4:

| Ingredients | Wt. % |
|---|---|
| Trisodium citrate (100%) | 6.0 |
| Na₄EDTA (40%) | 6.0 |
| Masodol 91-6 | 4.0 |
| Macat AO-8 | 3.0 |
| Maquat C-15 | 3.0 |
| Sodium metasilicate 5H₂O | 1.0 |
| Water | Balance |

Composition 4 effective at cleaning granite counter without streaks, removed red wine and sharpie stains from carpet, leaving a small amount of residue, cleaned painted door but removed a small amount of paint, cleaned shower doors without residue, cleaned oven top well but left a film, cleaned stainless steel but left a film and streaks, cleaned a greasy pan with baked on food residue, cleaned grease off a grill, cleaned grease off oven door.

### Composition 5:

| Ingredients | Wt. % |
|---|---|
| Maquat LATAC | 16.6 |
| Masodol 91-6 | 10.0 |
| Masodol 1-3 | 10.0 |
| Na₄EDTA, 38% | 10.0 |
| Maquat MQ2525M-50% | 3.125 |
| Sodium Metasilicate 5H₂O | 3.0 |
| Water | Balance |

### Composition 6:

| | |
|---|---|
| Masol BA-226 | 9.0 |
| Trisodium Citrate (100%) | 6.0 |
| Na₄EDTA (40%) | 4.5 |
| Water | Balance |

Composition 6 effective at cleaning granite counter without streaks, didn't remove red wine and sharpie stains from carpet, cleaned oven top but left a residue, cleaned stainless steel without streaking, moderately cleaned a greasy pan with baked on food residue.

### Examples

1. Composition 2 (5 mL) add 2 mL (40%) 91.25, mix with water and stir (result, phase separation)—no effect on dissolving bitumen
2. 5 mL composition 2, 1 mL Maquat C-15, 1 mL 91.25—stir and heat for 5 sec—no effect on dissolving bitumen
3. Composition 2—no effect on dissolving bitumen
4. 5 mL composition 2, 2 mL Masoteric C-2SF, heat 10 sec and mix—some reaction with bitumen
5. composition 3 mL composition 2, 3 mL C-2, 3 mL Masoteric C-2SF—early release
6. 2 mL C-2, 2 mL Masoteric C-2SF—release after 3 sec
7. 2 mL C-2, 2 mL Masoteric C-2SF—microwave 5 sec and mix—release after 5 sec (After the mixture binds with or holds the oil and pulls it to the bottom of the container, this is when the chemical breaks its bonds with the oil and “releases it” so that the oil can break free of the chemical and rejoin the floating oil layer)
8. 2 mL composition 2, 2 mL Masoteric C-2SF, 2 mL Maquat C-15—microwave 5 sec and mix—hold 10 sec, then partial release
9. 2 mL composition 2, 2 mL Masoteric C-2SF, 2 mL Maquat C-15—microwave 5 sec and mix—creates honeycomb, delayed release 2-5 min
10.2 mL composition 2, 1 mL Masoteric C-2SF, 1 mL Maquat C-15—microwave 5 sec and mix—creates smaller honeycomb, releases 40 sec
11.2 mL Masoteric C-2SF, 2 mL Maquat C-15, 1 mL composition 2—microwave 5 sec and mix—release but contaminated
12.2.5 mL MASOTERIC C-2SF, 2.5 mL Maquat C-15, 1.25 mL composition 2—microwave 5 sec and mix—breaks early, but 1 m 27 s all dissolved
13. composition 2 mL composition 2, 2 mL Maquat C-15, 2 mL Masoteric C-2SF, microwave 5 sec and mix—break at 2 min
14.7.5 mL composition 2, 2.5 mL Masoteric C-2SF—bonded to crude oil with release after 35 sec
15. 5 mL composition 2, 2.5 mL Masoteric C-2SF, 2.5 mL Maquat C-15—applied to crude oil, numerous breakthrough episodes (Breakthrough: Time for mixture to break through the layer of oil; penetrating the oil (making the oil bubble) and flowing into the underlying water)
16.10 mL composition 2, 1 mL Masodol 91-6—mix—limited results on crude/heavy oil
17.10 mL composition 2, 1 mL Maquat C-15—mix—accelerated reaction time, particles left at bottom
18.7.5 mL composition 2, 2.5 mL Maquat C-15—bleeding downwards and holding, 30 sec+pulling (Pulling: Pull of the mixture and oil combination downwards through the water phase. this is the “magic” of the process where oil instead of floating on the water phase is pulled to the bottom of the container)
19. Maquat MQ2525 50%, 30% by volume—not effective
20.2 mL composition 2, 2 mL Maquat C-15, 2 mL MASOTERIC C-2SF—2-5 min of honeycomb formation, then release (if diluted 25% with water, honeycombs break in 1-2 min)

We claim:

1. A composition comprising: PEG-15 cocomonium chloride, at least one amine oxide and at least one alcohol ethoxylate.

2. The composition of claim 1, wherein the PEG-15 cocomonium chloride is present in an amount of 3%-10% by weight.

3. The composition of claim 1, wherein the amine oxide is present in an amount of about 3% by weight and the alcohol ethoxylate is present in an amount of about 4% by weight.

4. The composition of claim 1, further comprising at least one additive selected from the group consisting of builders, chelating agents, buffers and hydrotropes.

5. A composition for use as a heavy oil production enhancement additive, bitumen additive, facility cleaning agent, soil cleaning agent, paraffin/scale/asphaltene inhibiting agent, or paraffin reduction agent, the composition comprising:
at least one quaternary ammonium chloride, at least one amine oxide and at least one alcohol ethoxylate.

6. The composition of claim 5, wherein the quaternary ammonium chloride is PEG-15 cocomonium chloride.

7. The composition of claim 6, wherein the PEG-15 cocomonium chloride is present in an amount of 3% to 10% by weight.

8. A method for preparing a composition comprising the steps of:
dissolving builder and buffer in water;
adding chelating agent;
adding PEG-15 cocomonium chloride, amine oxide and alcohol ethoxylate; and
adding water to the point of achieving clarity of the composition.

9. The method of claim 8, wherein the PEG-15 cocomonium chloride is present in an amount of 3% to 10% by weight of the composition.
